(19) United States
(12) Patent Application Publication
(10) Pub. No.: US 2017/0335897 A1
(43) Pub. Date: Nov. 23, 2017

(54) CLUTCH DISC SEGMENT WITH ELONGATED FOOT AND CLUTCH DISC ASSEMBLY INCLUDING CLUTCH DISC SEGMENTS WITH ELONGATED FEET

(71) Applicant: Schaeffler Technologies AG & Co. KG, Herzogenaurach (DE)

(72) Inventors: Jorge Arturo Martinez Torres, Puebla (MX); Juan Manuel Jimenez Rodriguez, Puebla (MX); Javier Takeshi Gonzalez Nagano, Puebla (MX); Angel Roberto Cortes Perez, Puebla (MX)

(21) Appl. No.: 15/159,102

(22) Filed: May 19, 2016

(51) Int. Cl. F16D 13/68

(52) U.S. Cl. CPC F16D 13/68; F16D 2300/12

(57) ABSTRACT

A clutch disc segment, including: an inner circumference; a body portion including an outer circumference and a plurality of holes arranged to receive a plurality of rivets for securing friction material to the body portion, and a segment including at least a first portion of the inner circumference and conforming to a plane; a first foot protrusion including a first hole for receiving a first rivet for securing the clutch disc segment to a retainer plate; and a second foot protrusion including a second hole for receiving a second rivet for securing the clutch disc segment to the retainer plate. One of the first or second foot protrusions is off-set from the plane in a first direction orthogonal to the plane.

### TECHNICAL FIELD

Disclosed herein is a clutch disc segments with elongated feet enabling circumferentially adjacent clutch disc segments to be fixedly connect to a retainer plate for a clutch disc assembly by a single rivet.

### BACKGROUND

FIG. 11 is a front view of prior art clutch disc assembly 200. Assembly 200 includes retainer plate 202 and clutch disc segments 204. Each segment 204 is fixedly connected to plate 202 by two rivets 206. Separate riveting operations are needed for each rivet 206 or one or more operations for multiple rivets are needed. Further, the large number of rivets 206 undesirably add to the mass of assembly 200.

### SUMMARY

According to aspects illustrated herein, there is provided a clutch disc segment, including: an inner circumference; a body portion including an outer circumference and a plurality of holes arranged to receive a plurality of rivets for securing friction material to the body portion, and a segment including at least a first portion of the inner circumference and conforming to a plane; a first foot protrusion including a first hole for receiving a first rivet for securing the clutch disc segment to a retainer plate; and a second foot protrusion including a second hole for receiving a second rivet for securing the clutch disc segment to the retainer plate. One of the first or second foot protrusions is off-set from the plane in a first direction orthogonal to the plane.

According to aspects illustrated herein, there is also provided a clutch disc assembly, including: a retainer plate; a first clutch disc segment including a first hole; a second clutch disc segment including a second hole; and a first rivet passing through the first and second holes and fixedly connecting the first and second clutch disc segments to the retainer plate.

According to aspects illustrated herein, there is provided a clutch disc assembly, including: a retainer plate; a first clutch disc segment including a first foot protrusion; a second clutch disc segment including a second foot protrusion; and a first rivet passing through the first and second foot protrusions and fixedly connecting the first and second clutch disc segments to the retainer plate.

### BRIEF DESCRIPTION OF THE DRAWINGS

Various embodiments are disclosed, by way of example only, with reference to the accompanying schematic drawings in which corresponding reference characters indicate corresponding parts, in which

FIG. 1 is a perspective view of a cylindrical coordinate system demonstrating spatial erminology;

FIG. 2 is a front view of an example clutch disc assembly with clutch discs having elongated and off-set feet;

FIG. 3 is a front view of the assembly in FIG. 2 with friction material;

FIG. 4 is a front view of an example clutch disc segment with an elongated and off-set foot shown in FIG. 2;

FIG. 5 is a perspective view of area 5 in FIG. 4;

FIG. 6 is bottom end view of the clutch disc segment in FIG. 4;

FIG. 7 is a perspective view of area 7 in FIG. 3;

FIG. 8 is a front view of an example clutch disc assembly with planar elongated foot protrusions;

FIG. 9 is a front view of an example clutch disc segment with a planar elongated foot shown in FIG. 8;

FIG. 10 is a bottom end view of the clutch disc segment shown in FIG. 9; and,

FIG. 11 is a front view of a prior art clutch disc assembly.

### DETAILED DESCRIPTION

At the outset, it should be appreciated that like reference characters on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

By “non-rotatably connected” components we mean: any time one of the components rotates, all of the components rotate; and relative rotation between the components is not possible. Axial or radial displacement between components is possible, but not required.

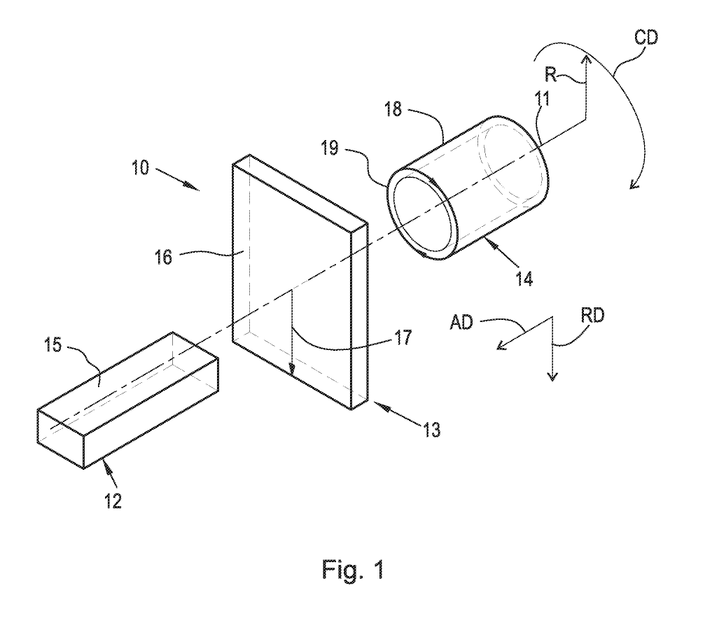

FIG. 1 is a perspective view of cylindrical coordinate system 10 demonstrating spatial terminology. The present application is at least partially described within the context of a cylindrical coordinate system. System 10 includes longitudinal axis 11, used as the reference for the directional and spatial terms that follow. Axial direction AD is parallel to axis 11. Radial direction RD is orthogonal to axis 11. Circumferential direction CD is defined by an endpoint of radius R (orthogonal to axis 11) rotated about axis 11.

To clarify the spatial terminology, objects 12, 13, and 14 are used. An axial surface, such as surface 15 of object 12, is formed by a plane co-planar with axis 11. Axis 11 passes through planar surface 15; however any planar surface co-planar with axis 11 is an axial surface. A radial surface, such as surface 16 of object 13, is formed by a plane orthogonal to axis 11 and co-planar with a radius, for example, radius 17. Radius 17 passes through planar surface 16; however any planar surface co-planar with radius 17 is a radial surface. Surface 18 of object 14 forms a circumferential, or cylindrical, surface. For example, circumference 19 passes through surface 18. As a further example, axial movement is parallel to axis 11, radial movement is orthogonal to axis 11, and circumferential movement is parallel to circumference 19. Rotational movement is with respect to axis 11. The adverbs “axially,” “radially,” and “circumferentially” refer to orientations parallel to axis 11, radius 17, and circumference 19, respectively. For example, an axially disposed surface or edge extends in direction AD, a radially disposed surface or edge extends in direction R, and a circumferentially disposed surface or edge extends in direction CD.

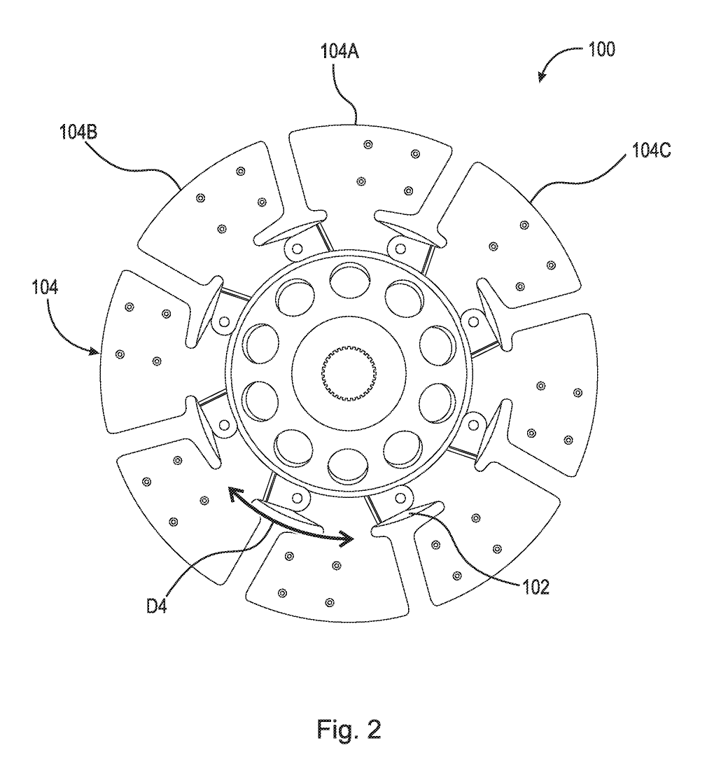

FIG. 2 is a front view of example clutch disc assembly 100 with clutch discs having elongated and off-set feet.

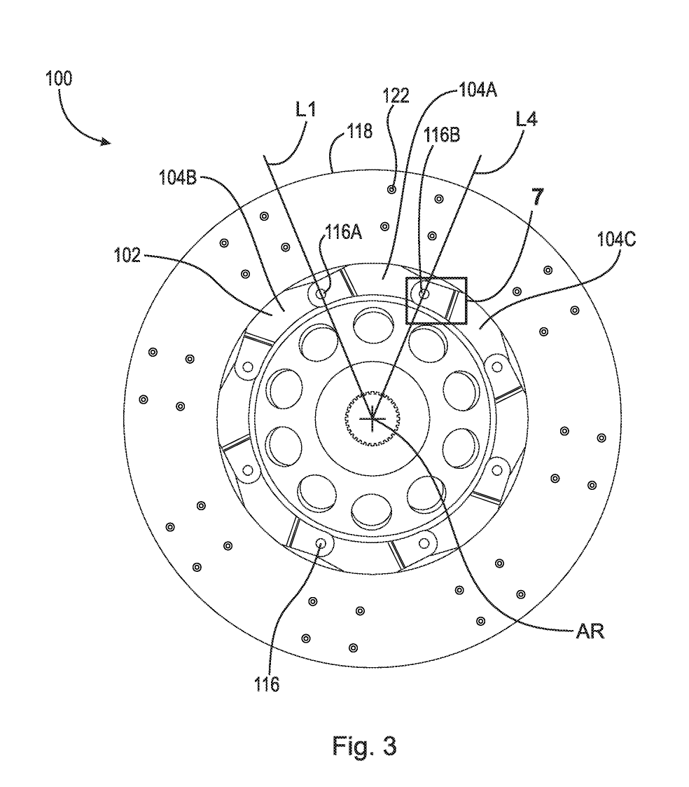

FIG. 3 is a front view of assembly 100 in FIG. 2 with friction material.

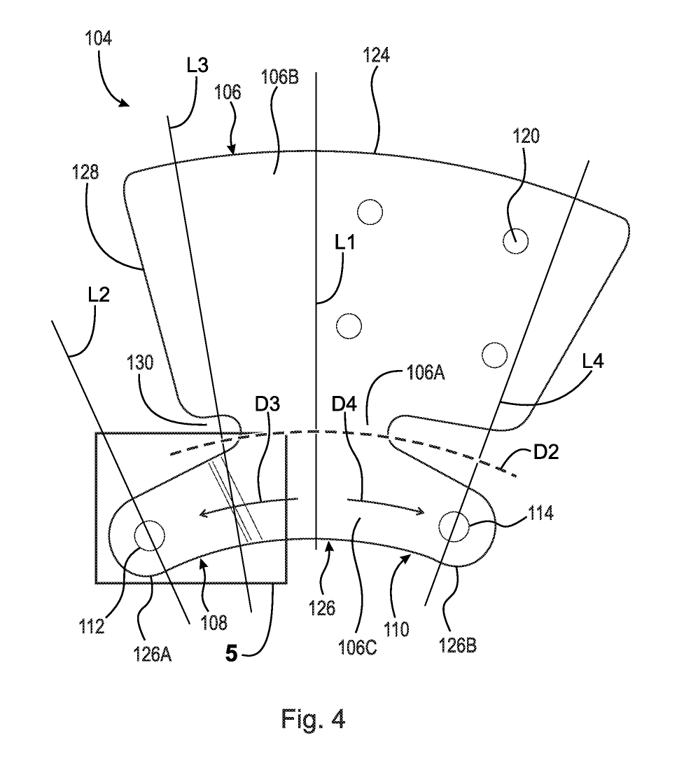

FIG. 4 is a front view of an example clutch disc segment with an elongated and off-set foot shown in FIG. 2. The following should be viewed in light of FIG. 2 through 4. Assembly 100 includes axis of rotation AR, retainer plate 102 and clutch disc segments 104. Each segment 104 includes body portion 106, foot protrusion 108 and foot protrusion 110. Protrusions 108 and 110 includes holes 112 and 114, respectively. For circumferentially adjacent segments 104, a single rivet 116 passes through: one of hole 112 or 114 for one segment and the other of hole 112 or 114 for the other segment. For example: rivet 116A passes through hole 112 for segment 104A and hole 114 for segment 104B; and, rivet 116B passes through hole 114 for segment 104A and hole 112 for segment 104C. Rivets 116 fixedly connect circumferentially adjacent segments 104 to each other and to retainer plate 102. It should be understood that the discussion of segment 104 below is applicable to each segment 104 is assembly 100 unless noted otherwise.

In an example embodiment, assembly 100 includes friction material 118 fixedly connected to segments 104. For example, each segment 104 includes holes 120 in body portion 106 and rivets 122 pass through material 118 and holes 120 to fixedly secure material 118 to segments 104.

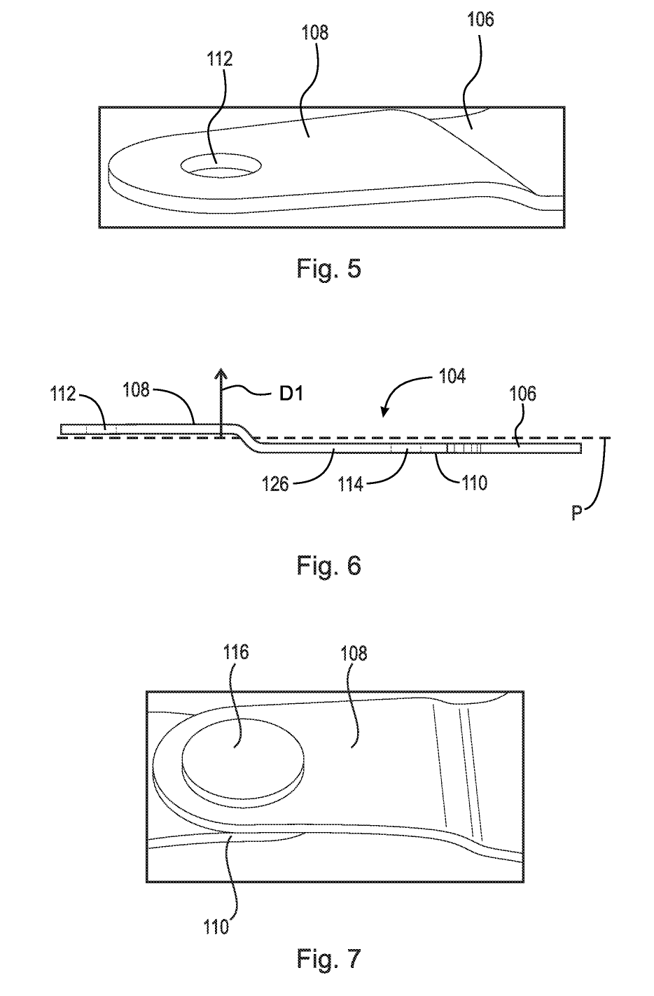

FIG. 5 is a perspective view of area 5 in FIG. 4.

FIG. 6 is bottom end view of segment 104 in FIG. 4. The following should be viewed in light of FIGS. 2 through 6. Segment 104 includes outer circumference 124 and inner circumference 126. In FIG. 2, circumferences 124 and 126 are radially outer and inner circumferences, respectively. Protrusions 108 and 110 includes portions 126A and 126B, respectively, of circumference 126.

In an example embodiment, body portion 106 includes: section 106A; section 106B radially outward of section 106A; and section 106C radially inward of section 106A. Section 106B includes circumference 124. Section 106C includes portion 126A of circumference 126. Protrusions 108 and 110 extend from section 106C. Section 106C conforms to plane P. That is, body portion 106 is flat or planar along plane P. In the example embodiment of FIGS. 2 through 6: protrusion 108 is offset from body portion 106 and plane P in direction Dl orthogonal to plane P; and protrusion 110 conforms to plane P. In FIG. 2, plane P is a radial plane orthogonal to axis AR and direction D1 is an axial direction parallel to axis of rotation AR. In an example embodiment, sections 106A, 106B and 106C all conform to plane P.

Line L1, orthogonal to circumference 126, passes through circumferences 124 and 126. Line L1 is between holes 112 and 114. In an example embodiment, line L2, orthogonal to circumference 126, passes through hole 108 without passing through circumference 124. In an example embodiment, line L2 is orthogonal to axis AR. In an example embodiment, segment 104 includes side edge 128 connecting circumferences 124 and 126. Edge 128 forms indentation 130. Line L3, orthogonal to circumference 126, passes through in sequence protrusion 108, indentation 130 and body portion 106. Line L2 does not pass through indentation 130. In an example embodiment, line L3 is orthogonal to axis AR. In FIG. 2, lines L1, L2, and L3 are radial lines orthogonal to axis of rotation AR. Section 106A is aligned with indentation 130 in direction D2, parallel to circumference 126. Referring to FIG. 2, direction D2 is a circumferential direction.

In an example embodiment, line L4 passes through hole 114 and circumference 124. In FIG. 2, line L4 is a radial line orthogonal to axis AR.

Protrusion 108 extends away from line L1 at least partially in direction D3 orthogonal to line L1 and protrusion 110 extends away from line L1 at least partially in direction D4, opposite direction D3. Referring to FIG. 2, directions D3 and D4 are circumferential directions.

FIG. 7 is a perspective view of area 7 in FIG. 3. FIG. 7 shows the axial overlap of protrusion 108 for segment 104C with protrusion 110 for segment 104A. As seen in FIG. 7, each portion 110 is sandwiched between a respective portion 108 and retainer plate 102.

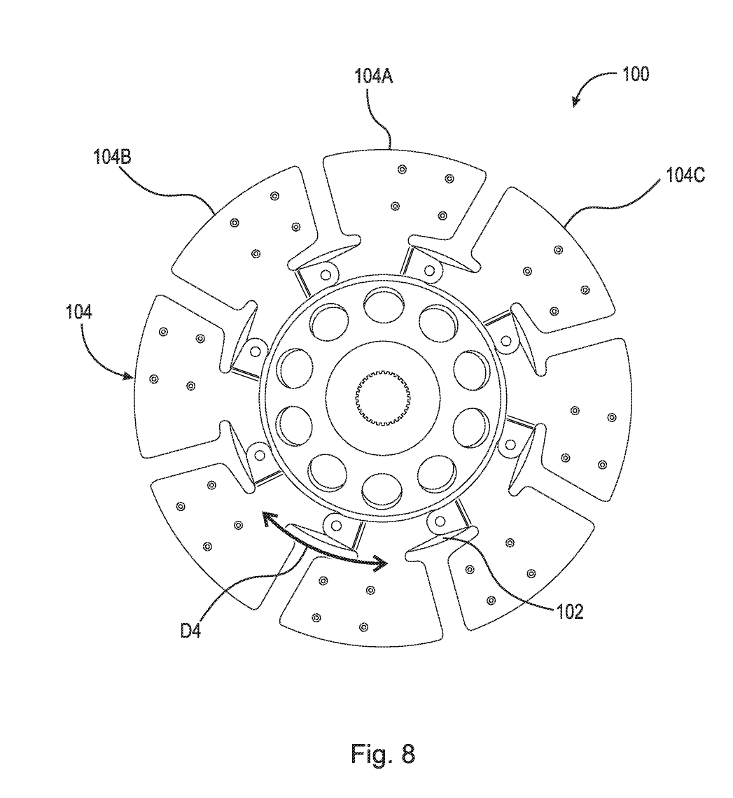

FIG. 8 is a front view of example clutch disc assembly 100 with planar elongated foot protrusions.

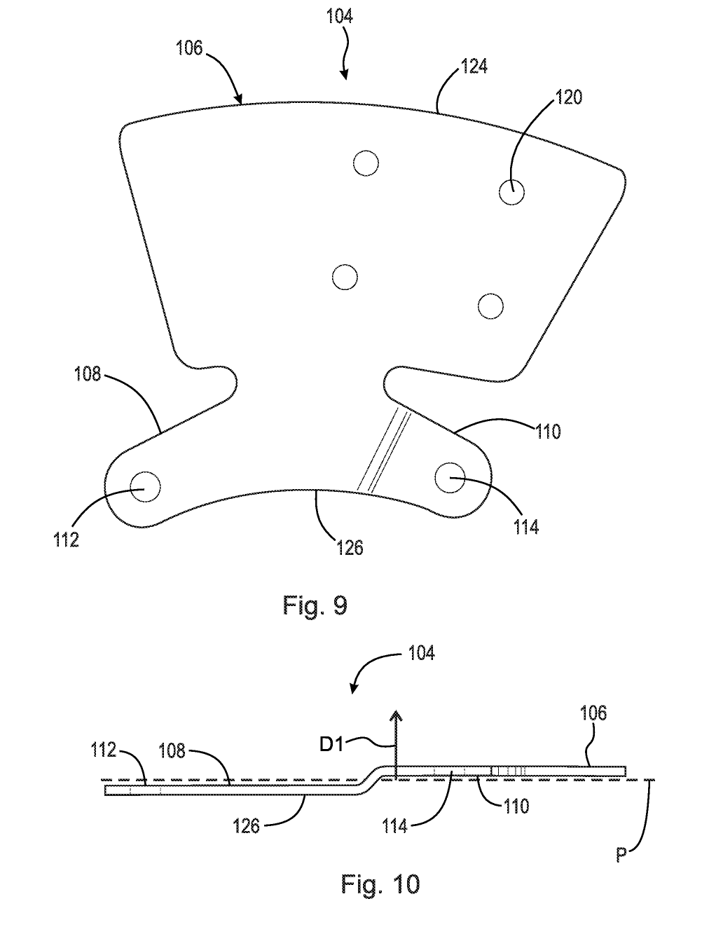

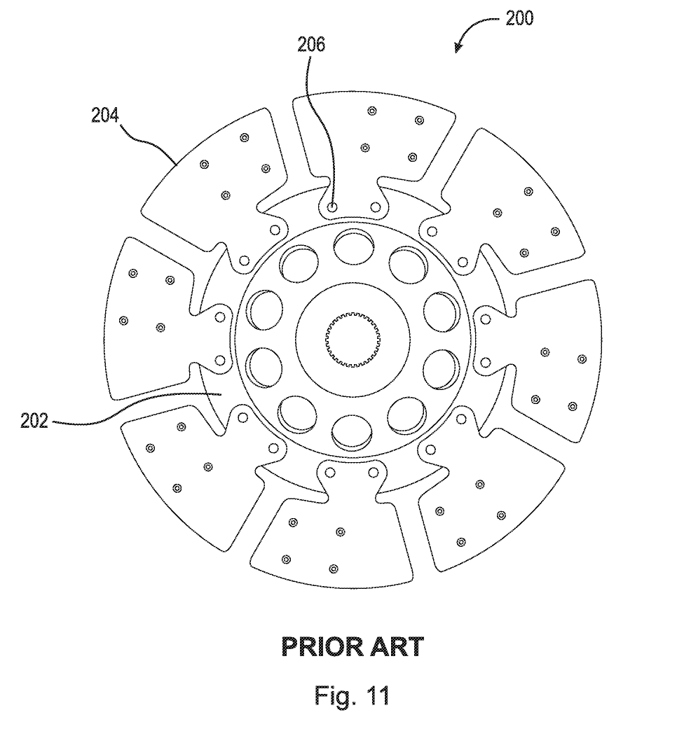

FIG. 9 is a front view of an example clutch disc segment with a planar elongated foot shown in FIG. 8.

FIG. 10 is a bottom end view of the clutch disc segment shown in FIG. 9. The discussion for FIGS. 2 through 4 is applicable to FIGS. 8 through 10 except as noted. As noted above, body section 106C conforms to plane P. That is, body section 106C is flat or planar along plane P. In the example embodiment of FIGS. 8 through 10: protrusion 110, rather than protrusion 108, is offset from body portion 106C and plane P in direction Dl orthogonal to plane P; and protrusion 108, rather than protrusion 110, conforms to plane P. In the example of FIGS. 8 through 10, each protrusion 108 is axially sandwiched between a respective protrusion 110 and retainer plate 102.

Advantageously, segments 104 and assembly 100 address the problems noted above. For example, half as many rivets 116 are needed for assembly 100 as compared to rivets 208 for prior art assembly 200. Thus, the number and/or complexity of riveting operations is reduced and the mass of assembly 100 is reduced in comparison to that of assembly 200.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A clutch disc segment, comprising:
an inner circumference;
a body portion including:
an outer circumference and a plurality of holes arranged to receive a plurality of rivets for securing friction material to the body portion; and,
a section including at least a first portion of the inner circumference and conforming to a plane;
a first foot protrusion including a first hole for receiving a first rivet for securing the clutch disc segment to a retainer plate; and,
a second foot protrusion including a second hole for receiving a second rivet for securing the clutch disc segment to the retainer plate, wherein one of the first or second foot protrusions is off-set from the plane in a first direction orthogonal to the plane.

2. The clutch disc segment of claim 1, wherein the first and second foot protrusions include second and third portions of the inner circumference, respectively.

3. The clutch disc segment of claim 2, wherein:
a first line, orthogonal to the inner circumference, passes through the outer circumference; and,
a second line, orthogonal to the inner circumference, passes through the first hole without passing through the outer circumference.

4. The clutch disc segment of claim 3, further comprising:
a side edge connecting the inner and outer circumferences; and,
an indentation in the side edge, wherein:
a third line, orthogonal to the inner circumference, passes through in sequence the first foot protrusion, the indentation, and the outer circumference; and,
a fourth line, orthogonal to the inner circumference, passes through the first hole without passing through the indentation.

5. The clutch disc segment of claim 2, wherein a first line, orthogonal to the inner circumference, passes through the second hole and the outer circumference.

6. The clutch disc segment of claim 1, wherein:
the first foot protrusion extends away from a line at least partially in a second direction orthogonal to the line;
the second foot protrusion extends away from the line at least partially in a third direction opposite the second direction; and,
the line:
is orthogonal to the inner circumference; and,
between the first and second holes.

7. A clutch disc assembly, comprising:
a retainer plate;
a first clutch disc segment including a first hole;
a second clutch disc segment including a second hole; and,
a first rivet passing through the first and second holes and fixedly connecting the first and second clutch disc segments to the retainer plate.

8. The clutch disc assembly of claim 7, wherein the first clutch disc segment includes a third hole, the clutch disc assembly further comprising:
a third clutch disc segment including a fourth hole; and,
a second rivet passing through the third and fourth holes and fixedly connecting the first and third clutch disc segments to the retainer plate.

9. The clutch disc assembly of claim 7, further comprising friction material fixedly connected to the first and second clutch plate segments.

10. The clutch disc assembly of claim 7, further comprising:
an axis of rotation, wherein:
the first clutch disc segment includes:
a radially outer circumference; and,
a foot protrusion including the first hole; and,
a first line, in a radial direction orthogonal to the axis of rotation, passes through the first hole without passing through the radially outer circumference.

11. The clutch disc assembly of claim 10, wherein the first clutch disc segment includes a body portion with a plurality of holes, the clutch disc assembly further comprising:
friction material; and,
a plurality of rivets passing through the plurality of holes and fixedly connecting the friction material to the body portion.

12. The clutch disc assembly of claim 7, further comprising:
a plurality of clutch disc segments, wherein:
the first and second clutch disc segments are included in the plurality of clutch disc segments; and,
each clutch disc segment included in the plurality of clutch disc segments is fixedly connected to a respective circumferentially adjacent clutch disc segment, included in the plurality of clutch disc segments, by a single respective rivet passing through said each clutch disc segment and the respective circumferentially adjacent clutch disc segment.

13. A clutch disc assembly, comprising:
a retainer plate;
a first clutch disc segment including a first foot protrusion;
a second clutch disc segment including a second foot protrusion; and,
a first rivet passing through the first and second foot protrusions and fixedly connecting the first and second clutch disc segments to the retainer plate.

14. The clutch disc assembly of claim 13, further comprising:
an axis of rotation, wherein the first foot protrusion overlaps the second foot protrusion in an axial direction parallel to the axis of rotation.

15. The clutch disc assembly of claim 13, wherein the first clutch disc segment includes a third foot protrusion, the clutch disc assembly further comprising:
a third clutch disc segment including a fourth foot protrusion; and,
a second rivet passing through the third and fourth foot protrusions and fixedly connecting the first and third clutch disc segments to the retainer plate.

16. The clutch disc assembly of claim 15, further comprising:
an axis of rotation, wherein:
the first clutch disc segment includes:
a radially inner circumference; and,
a body portion including a section:
including a portion of the radially inner circumference; and, conforming to a plane; and,
the third foot protrusion is offset from the plane in a direction parallel to the axis of rotation.

17. The clutch disc assembly of claim 16, wherein the third foot protrusion overlaps the fourth foot protrusion in the direction.

18. The clutch disc assembly of claim 13, further comprising:
an axis of rotation, wherein:
the first clutch disc segment includes a radially outer circumference; and,
a first line, in a radial direction orthogonal to the axis of rotation, passes through the first rivet without passing through the radially outer circumference.

19. The clutch disc assembly of claim 13, further comprising:
an axis of rotation, wherein:
the first clutch disc segment includes:
a radially inner circumference; and,
a body portion including a section:
including a portion of the radially inner circumference; and, conforming to a plane; and,
the first foot protrusion is offset from the plane in a direction parallel to the axis of rotation.

20. The clutch disc assembly of claim 13, further comprising:
a plurality of clutch disc segments, wherein:
the first and second clutch disc segments are included in the plurality of clutch disc segments; and,
each clutch disc segment included in the plurality of clutch disc segments is fixedly connected to a respective circumferentially adjacent clutch disc segment, included in the plurality of clutch disc segments, by a respective single rivet.
